(19) United States
(12) Patent Application Publication
(10) Pub. No.: US 2011/0193831 A1
(43) Pub. Date: Aug. 11, 2011

(54) DISPLAY DEVICE AND ELECTRONIC APPARATUS

(75) Inventor: Takashi Kunimori, Tottori (JP)

(73) Assignee: SONY CORPORATION, Tokyo (JP)

(21) Appl. No.: 13/022,084

(22) Filed: Feb. 7, 2011

(30) Foreign Application Priority Data
Feb. 9, 2010 (JP) P2010-026238

(51) Int. Cl. G09G 5/00

(52) U.S. Cl. 345/204

(57) ABSTRACT

A display device includes a switching element that is formed for each pixel; a gate line that is connected to the switching element; a first scanning line driving circuit and a second scanning line driving circuit that are connected to the gate line; and a control unit that normally controls the first scanning line driving circuit to output a signal driving the switching element, and controls an output of the second scanning line driving circuit to be brought into a high-impedance state.

### CROSS REFERENCES TO RELATED APPLICATIONS

The present application claims priority to Japanese Priority Patent Application JP 2010-026238 filed in the Japan Patent Office on Feb. 9, 2010, the entire contents of which are hereby incorporated by reference.

### BACKGROUND

The present application relates to a display device and an electronic apparatus, and particularly, to a display device and an electronic apparatus which have a plurality of scanning line driving circuits connected to each of a plurality of gate lines.

In the related art, a display device and an electronic apparatus which have a plurality of scanning line driving circuits connected to each of a plurality of gate lines have been disclosed (for example, see Japanese Unexamined Patent Application Publication Translation of PCT Application No. 6-505606).

In Japanese Unexamined Patent Application Publication Translation of PCT Application No. 6-505606, a display device including a plurality of selection lines (gate lines), a first selection line-scanner (scanning line driving circuit) connected to one end of each of the selection lines, and a second selection line-scanner (scanning line driving circuit) connected to the other end of each of the selection lines has been disclosed. In the display device, signals output simultaneously to one selection line while the first selection line scanner and the second selection line scanner are simultaneously driven. Accordingly, even when a defect is generated in any one of the first selection line scanner and the second selection line scanner, it is possible to drive the display device. Consequently, it is possible to improve a yield of the display device.

However, in the display device of Japanese Unexamined Patent Application Publication Translation of PCT Application No. 6-505606, a power for driving two selection line scanners is necessary in order to simultaneously drive the first selection line scanner and the second selection line scanner. Due to this, there is a problem of an increase in power consumption.

Thus, in the related art, a technique for solving the above mentioned problem has been suggested (See, Japanese Unexamined Patent Application Publication No. 2006-343746). In Japanese Unexamined Patent Application Publication No. 2006-343746, a display device including a plurality of gate lines, a main gate driving unit (scanning line driving circuit) connected to one end of each of the gate lines, and a sub gate driving unit (scanning line driving circuit) connected through a switching unit installed in the other end of each of the gate lines has been disclosed. In this display device, the switching unit is normally maintained in a cutoff state (OFF state), and is configured to conduct the sub gate driving unit and the gate line, as necessary. In addition, when a defect is generated in the main gate driving unit, the sub gate driving unit and the gate line are connected to each other by bringing the switching unit into a conductive state (ON state), signals are outputted from the sub gate driving unit to the gate line.

### SUMMARY

However, in the display device of Japanese Unexamined Patent Application Publication No. 2006-343746, since the switching unit used for cutting off or conducting the gate line and the sub gate driving unit is installed for each gate line, there is a problem in that circuit configuration becomes complicated.

It is desirable to provide a display device and an electronic apparatus which can improve a yield, and simplify circuit configuration while suppressing an increase of power consumption.

According to an embodiment, there is provided a display device including a switching element that is formed on a surface of a liquid crystal layer side of a first substrate for each pixel; a gate line that is connected to the switching element; a first scanning line driving circuit and a second scanning line driving circuit that are connected to the gate line; and a control unit that normally controls the first scanning line driving circuit to output a signal driving the switching, and controls an output of the second scanning line driving circuit to be brought into a high-impedance state.

In the display device, according to the embodiment, the control unit may control the first scanning line driving circuit to normally output the signal driving the switching element and control the output of the second scanning line driving circuit to be brought into the high-impedance state, so that a signal from the second scanning line driving circuit is not outputted when a signal from the first scanning line driving circuit is outputted. Accordingly, unlike a case where the signal is simultaneously outputted from both the first scanning line driving circuit and the second scanning line driving circuit, it may be possible to suppress an increase in power consumption. In addition, the control unit may control the output of the second scanning line driving circuit to be brought into the high-impedance state, so that the signal may not be outputted from the second scanning line driving circuit. Accordingly, unlike a case where a switching unit is installed between the second scanning line driving circuit and each of the gate lines so that the signal is not outputted from the second scanning line driving circuit, it may be possible to simplify circuit configuration.

In the display device, according to the embodiment, it is preferable that when an output signal from the first scanning line driving circuit is abnormal, the control unit controls an output of the first scanning line driving circuit to be brought into the high-impedance state, and the second scanning line driving circuit is configured to perform a switching control so that the signal driving the switching element is outputted. Due to this configuration, when the first scanning line driving circuit is not normally driven (abnormally), the display device may be treated as a defective product, and the second scanning line driving circuit which is normally driven may be used instead of the first scanning line driving circuit which is abnormally driven, so that the display device may be treated as a non-detective product. In addition, when the life of the first scanning line driving circuit has expired due to deterioration of the first scanning line driving circuit, the first scanning line driving circuit may be switched into the second scanning line driving circuit, so that it may be possible to output, from the second scanning line driving circuit, the signal driving the switching element. Accordingly, the life of the display device may be doubled.

In this case, it is preferable that the first scanning line driving circuit is configured so that a signal for outputting the signal driving the switching element is inputted to the first scanning line driving circuit, and a signal for bringing an output into the high-impedance state is inputted to the second scanning line driving circuit. Further, when the output signal from the first scanning line driving circuit is abnormal, the control unit may perform a switching control of using the second scanning line driving circuit without using the first scanning line driving circuit by switching the signal inputted to the first scanning line driving circuit and the signal inputted to the second scanning line driving circuit to each other. Due to this configuration, the second scanning line driving circuit which is normally driven may be used instead of the first scanning line driving circuit which is abnormally driven, so that the signal driving the switching element may be outputted from the second scanning line driving circuit which is normally driven.

In the display device including the first scanning line driving circuit and the second scanning line driving circuit which are configured such that the signal is inputted, it is preferable that the control unit controls the first scanning line driving circuit to be prevented from being driven by fixing at least a clock signal, among the signals inputted to the first scanning line driving circuit, to be in an OFF potential, so that the output of the first scanning line driving circuit is brought into the high-impedance state. Due to this configuration, by only switching the clock signal into the OFF potential, the signal from the first scanning line driving circuit may be readily prevented from being outputted.

In this case, it is preferable that the control unit controls the first scanning line driving circuit to be prevented from being driven by fixing not only the clock signal but Further a scanning line enable signal, among the signals inputted to the first scanning line driving circuit, to be in the OFF potential, so that the output of the first scanning line driving circuit is brought into the high-impedance state. Due to this configuration, by only switching the clock signal and the scanning line enable signal into the OFF potential, the signal from the first scanning line driving circuit may be readily prevented from being outputted. In particular, the high-impedance state may be achieved by only using a predetermined signal without adding an additional circuit.

In the display device including the first scanning line driving circuit and the second scanning line driving circuit which are configured such that the signal is inputted, it is preferable that each of the first scanning line driving circuit and the second scanning line driving circuit includes a transistor connected to the gate line through which a signal is outputted, and the control unit controls the transistor connected to the gate line to be brought into an off state by fixing a signal, inputted to a gate electrode of the transistor of the first scanning line driving circuit, to be in the OFF potential, so that the output of the first scanning line driving circuit is brought into the high-impedance state. Due to this configuration, by only switching the signal inputted to the gate electrode of the transistor of the first scanning line driving circuit into the OFF potential, the signal from the first scanning line driving circuit may be readily prevented from being outputted.

In the display device according to the embodiment, it is preferable that the control unit is configured to determine whether the output signal from any one of the first scanning line driving circuit and the second scanning line driving circuit is abnormal. Due to this configuration, whether any one of the first scanning line driving circuit and the second scanning line driving circuit is normally driven can be determined.

According to another embodiment, there is provided an electronic apparatus having any of the above configurations including the display device. Due to this configuration, it may be possible to obtain the electronic apparatus including the display device which may improve a yield, and simplify circuit configuration while suppressing an increase in power consumption.

Additional features and advantages are described herein, and will be apparent from the following Detailed Description and the figures.

### BRIEF DESCRIPTION OF THE FIGURES

FIG. 1 is a plan view illustrating a liquid crystal display apparatus according to an embodiment;

FIG. 2 is a block diagram illustrating a liquid crystal display apparatus according to an embodiment;

FIG. 3 is a block diagram illustrating a configuration of a main scanning line driving circuit and a sub scanning line driving circuit of a scanning line driving circuit according to an embodiment;

FIG. 4 is an equivalent circuit diagram illustrating a configuration of a V scanner block of a scanning line driving circuit according to an embodiment;

FIG. 5 is a flowchart illustrating a switching operation performed between a main scanning line driving circuit and a sub scanning line driving circuit of a scanning line driving circuit according to an embodiment;

FIG. 6 is a timing chart illustrating operations of a main scanning line driving circuit and a sub scanning line driving circuit of a scanning line driving circuit according to an embodiment;

FIG. 7 is a diagram illustrating a first example of an electronic apparatus using a liquid crystal display device according to an embodiment;

FIG. 8 is a diagram illustrating a second example of an electronic apparatus using a liquid crystal display device according to an embodiment;

FIG. 9 is a diagram illustrating a third example of an electronic apparatus using a liquid crystal display device according to an embodiment;

FIG. 10 is a diagram illustrating a modified example of a liquid crystal display device according to an embodiment; and

FIG. 11 is an equivalent circuit diagram illustrating a modified example of circuit configuration of a V scanner block of a liquid crystal display device according to an embodiment.

### DETAILED DESCRIPTION

Embodiments of the present application will be described below in detail with reference to the drawings.

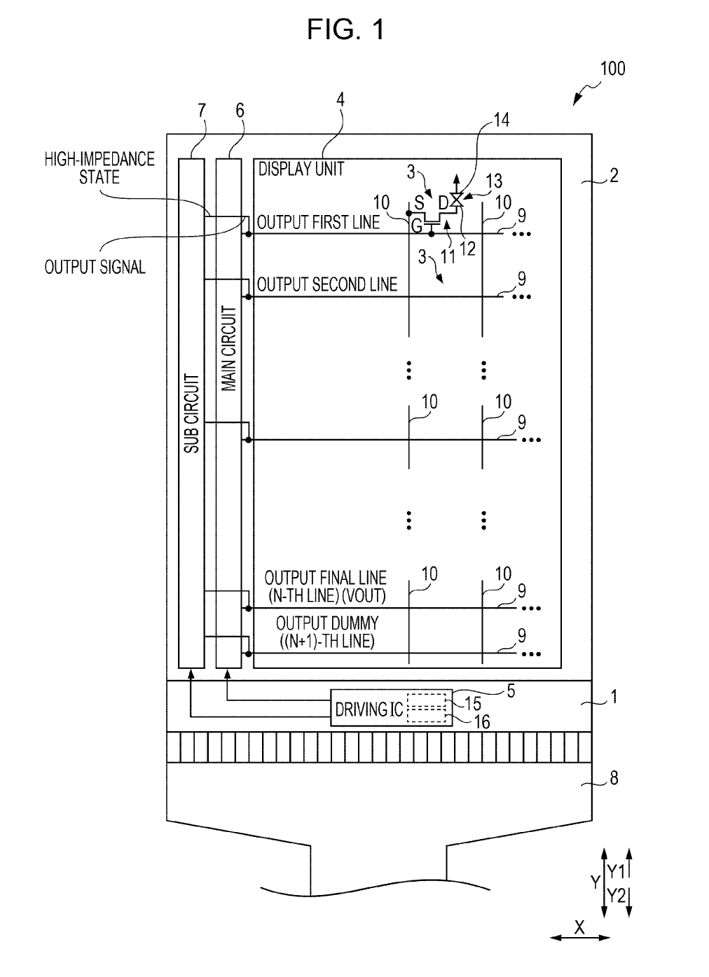

A configuration of a liquid crystal display device 100 according to an embodiment will be described in detail with reference to FIGS. 1 to 4.

As illustrated in FIG. 1, the liquid crystal display device 100 according to an embodiment includes a display unit 4 having a pair of Thin Film Transistor (TFT) substrates 1, a counter substrate 2, and a plurality of pixels 3, a driving Integrated Circuit (IC) 5 for driving the liquid crystal display device 100, a main scanning line driving circuit 6 installed on an outer surface of the TFT substrate 1 and a sub scanning line driving circuit 7, and a Flexible Printed Circuit 8 (FPC) outputting various signals to the driving IC 5. Further, the liquid crystal display device 100 is an example of “a display device” of the present application. In addition, the main scanning line driving circuit 6 is an example of “a first scanning line driving circuit” of the present application, and the sub scanning line driving circuit 7 is an example of “a second scanning line driving circuit” of the present application.

In addition, the display unit 4 includes a plurality of gate lines 9 extended along an X direction and a plurality of data lines 10 extended along a Y direction and slightly orthogonal to the gate line 9. Further, each of the plurality of gate lines 9 is connected to the main scanning line driving circuit 6 and the sub scanning line driving circuit 7. The plurality of gate lines 9 are arranged in the order of a first line, a second line, . . . , an N-th line, and an (N+1)-th line from the side of a Y1 direction to the side of a Y2 direction while being installed along the Y direction of the TFT substrate 1. Further, the pixel 3 is installed in an area in which the gate line 9 and the data line 10 cross each other. Further, a thin film transistor 11 for switching is installed in the pixel 3. Further, the thin film transistor 11 is an example of “a switching element” of the present application. A source electrode (S) of the thin film transistor 11 is connected to the data line 10, and a gate electrode (G) of the thin film transistor 11 is connected to the gate line 9. In addition, a drain electrode (D) of the thin film transistor 11 is connected to a pixel electrode 12. Further, a counter electrode 14 is installed to face the pixel electrode 12 via a liquid crystal layer 13.

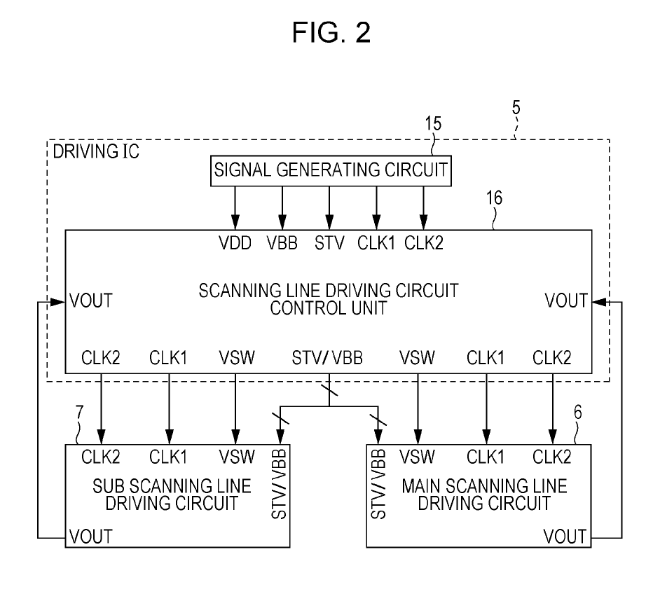

In addition, as illustrated in FIG. 2, the driving IC 5 includes a signal generation circuit 15 and a scanning line driving circuit control unit 16. Further, the scanning line driving circuit control unit 16 is an example of a “control unit” of the present application. The signal generation circuit 15 generates an H-level VDD potential, an L-level VBB potential, an STV signal (start signal), a pulse-shaped CLK1 (clock 1) signal, and a CLK2 (clock 2) signal, that is, an inversion signal of the CLK1 signal, and outputs the generated signals to the scanning line driving circuit control unit 16. In addition, the scanning line driving circuit control unit 16 controls the main scanning line driving circuit 6 and the sub scanning line driving circuit 7 to output a VSW signal (scanning line enable signal), the CLK1 signal, the CLK2 signal, the STV signal, and the VBB potential. Further, signal (VOUT, see FIG. 1) outputted from the gate line 9 (final line) contributing to a display, among the gate lines 9 connected to the main scanning line driving circuit 6 and the sub scanning line driving circuit 7, is outputted (fed back) to the scanning line driving circuit control unit 16.

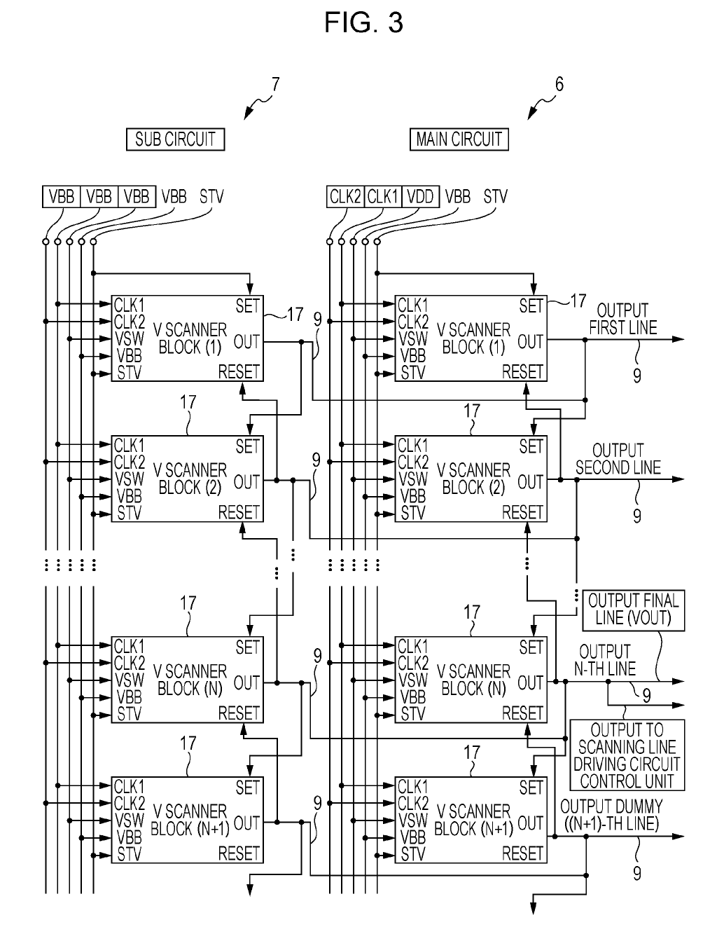

As illustrated in FIG. 3, each of the main scanning line driving circuit 6 and the sub scanning line driving circuit 7 output signals, and includes a plurality of V scanner blocks 17 for transmitting the signal to the next stage. Further, the V scanner block 17 is an example of “a scanning line driving circuit unit” of the present application. Each of the plurality of V scanner blocks 17 is connected to the first line, the second line, . . . , the N-th line, and the (N+1)-th line of the gate lines 9. Further, the V scanner block 17 connected to the gate line 9 of the first line is illustrated as a V scanner block (1), the V scanner block 17 connected to the gate line 9 of the second line is illustrated as a V scanner block (2), the V scanner block 17 connected to the gate line 9 of the N-th line is illustrated as a V scanner block (N), and the V scanner block 17 connected to the gate line 9 of the (N+1)-th line is illustrated as a V scanner block (N+1). Further, the V scanner block 17 of the main scanning line driving circuit 6 and the V scanner block 17 of the sub scanning line driving circuit 7 have the same circuit configuration.

In addition, the V scanner block 17 of each of the main scanning line driving circuit 6 and the sub scanning line driving circuit 7 includes a CLK1 terminal where the CLK1 signal is inputted, a CLK2 terminal where the CLK2 signal is inputted, a VSW terminal where the VDD potential or the VBB potential is inputted, a VBB terminal where the VBB potential is inputted, an STV terminal and SET terminal where the STV signal is inputted, an OUT terminal for outputting a signal to the gate line 9, and an RESET terminal where the signal from the OUT terminal of the V scanner block 17 of the next stage is inputted.

In addition, the signal (VOUT) outputted from the N-th line (final line) contributing to a display of the V scanner block 17 of each of the main scanning line driving circuit 6 and the sub scanning line driving circuit 7 is outputted (fed back) even to the scanning line driving circuit control unit 16 as illustrated in FIG. 2. Whether a magnitude of the signal having been fed back is normal or not (whether the magnitude of the signal is within a range of a predetermined magnitude of the signal) is determined by the scanning line driving circuit control unit 16. Further, the range of the predetermined magnitude of the signal is, for example, a range of less than about −10V or more than about +15V. Consequently, when the magnitude of the outputted signal is outside the range of less than about −10V or more than about +15V, the magnitude of the signal is determined to be normal, and when the magnitude of the signal is within the range of less than about −10V or more than about +15V, the magnitude of the signal is determined to be abnormal.

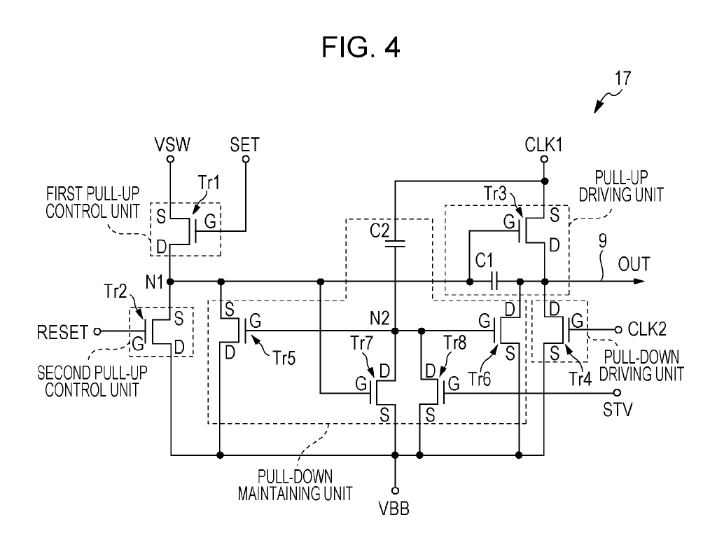

In addition, as for a detailed configuration of the V scanner block 17, the V scanner block 17 is configured from eight n-channel transistors and two capacitors, as illustrated in FIG. 4. Specifically, the V scanner block 17 includes a first pull-up control unit having a transistor Tr1, a second pull-up control unit having a transistor Tr2, a pull-up driving unit having a transistor Tr3 and a capacitor C1, a pull-down driving unit having a transistor Tr4, and a pull-down maintaining unit having a transistor Tr5, a transistor Tr6, a transistor Tr7, a transistor Tr8, and a capacitor C2. Further, the transistors Tr1 to Tr8 have an active layer formed from amorphous silicon.

A source electrode (S) of the transistor Tr1 is connected to the VSW terminal. Further, a gate electrode (G) of the transistor Tr1 is connected to the SET terminal. Further, the STV signal (start signal) is inputted to the SET terminal of the V scanner block 17, and a signal outputted from the OUT terminal of the V scanner block 17 of the previous stage is inputted to the SET terminal of the V scanner block 17 after the second line. Further, a drain electrode (D) of the transistor Tr1 is connected to a source electrode (S) of the transistor Tr2, a gate electrode (G) of the transistor Tr3, one electrode of the capacitor C1, a source electrode (S) of the transistor Tr5, and a gate electrode (G) of the transistor Tr7.

A gate electrode (G) of the transistor Tr2 is connected to the RESET terminal. Further, a signal outputted from the OUT terminal of the V scanner block 17 of the next stage is inputted to the RESET terminal. Further, a drain electrode (D) of the transistor Tr2 is connected to a source electrode (S) of the transistor Tr4, a drain electrode (D) of the transistor Tr5, a source electrode (S) of the transistor Tr6, a source electrode (S) of the transistor Tr7, a source electrode (S) of the transistor Tr8, and the VBB terminal.

A source electrode (S) of the transistor Tr3 is connected to the CLK1 terminal and one electrode of the capacitor C2. Further, a drain electrode (D) of the transistor Tr3 is connected to the other electrode of the capacitor C1, a drain electrode (D) of the transistor Tr4, a drain electrode (D) of the transistor Tr6, and the OUT terminal (gate line 9).

A gate electrode (G) of the transistor Tr4 is connected to the CLK2 terminal. Further, a gate electrode (G) of the transistor Tr5 is connected to a gate electrode (G) of the transistor Tr6, a drain electrode (D) of the transistor Tr7, a drain electrode (D) of the transistor Tr8, and the other electrode of the capacitor C2. Further, a gate electrode (G) of the transistor Tr8 is connected to the STV terminal. Further, the start signal is inputted to the STV terminal.

Hereinafter, control operations of the main scanning line driving circuit and sub scanning line driving circuit of the scanning line driving circuit control unit will be described in detail with reference to FIGS. 3 to 5.

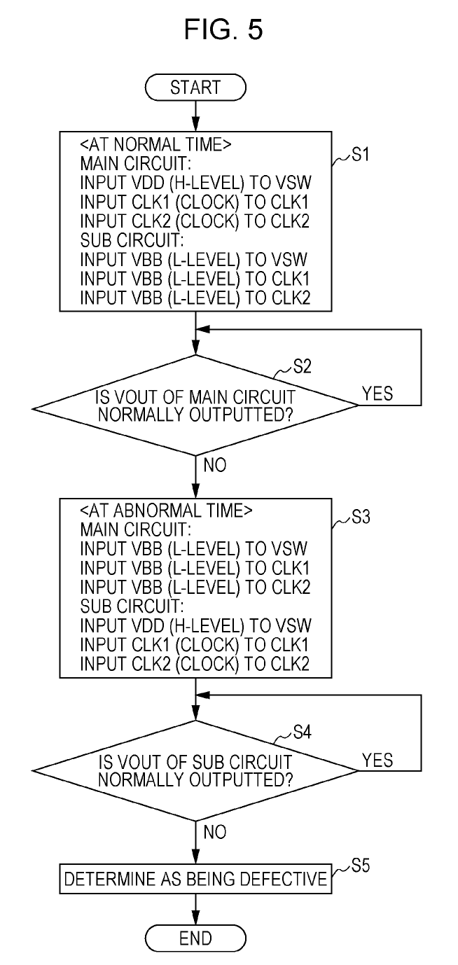

According to the embodiment, normally, the main scanning line driving circuit 6 is used, and the sub scanning line driving circuit 7 is not used. Consequently, a signal is outputted from the OUT terminal of the main scanning line driving circuit 6, and a signal is not outputted from the OUT terminal of the sub scanning line driving circuit 7 because the sub scanning line driving circuit 7 is in the high-impedance state (Hi-z state (floating state)). Specifically, as for the V scanner block 17 (1) (see, FIG. 3) connected to the gate line 9 of the first line of the main scanning line driving circuit 6, as illustrated in FIG. 5, in step S1, an H-level VDD potential is inputted to a VSW terminal of the V scanner block 17, a CLK1 signal of a clock signal is inputted to a CLK1 terminal, a CLK2 signal is inputted to a CLK2 terminal, a VBB potential is inputted to a VBB terminal, and an STV signal (start signal) is inputted to an STV terminal and an SET terminal. Here, detailed operations of the main scanning line driving circuit 6 will be described later. Further, a signal is outputted to the gate line 9 of the first line from the OUT terminal, and thereby a thin film transistor 11 of the display unit 4 is driven. Further, the signal outputted from the OUT terminal is inputted to the SET terminal of the next stage (V scanner block (2)), and a signal outputted from an OUT terminal of the (V scanner block (2)) is inputted to an SET terminal of the (V scanner block (N)). In this manner, the signal outputted from each of the V scanner blocks 17 is sequentially transmitted to the V scanner block 17 of the next stage.

In addition, in this embodiment, unlike the above described main scanning line driving circuit 6, in the V scanner block (1) (see, FIG. 3) connected to the gate line 9 of the first line of the sub scanning line driving circuit 7, an L-level VBB potential (OFF potential) is normally inputted to the VSW terminal, the CLK1 terminal, and the CLK2 terminal. Here, detailed operations of the sub scanning line driving circuit 7 will be described later. Accordingly, since the V scanner block (1) connected to the gate line 9 of the first line of the sub scanning line driving circuit 7 is brought into a high-impedance state, a signal is not outputted to the gate line 9 of the first line from the OUT terminal.

Next, in step S2, a signal is outputted from the V scanner block 17 of the final line (N-th line) of the main scanning line driving circuit 6 to the scanning line driving circuit control unit 16, and whether the outputted signal is normal or not is determined. Subsequently, the scanning line driving circuit control unit 16 determines whether the outputted signal is outside a range of between approximately −10V and +15V. Subsequently, when the outputted signal is determined to be outside the range of approximately between −10V to +15V, whether the outputted signal is normal is determined, and a control operation of step S2 is repeatedly performed. In addition, in step S2, when the outputted signal is within the range of approximately between −10V to +15V, the outputted signal is determined to be abnormal, step S3 starts.

Next, in step S3, when the outputted signal is abnormal, the scanning line driving circuit control unit 16 controls the signal inputted to the main scanning line driving circuit 6 to be switched to/from the signal inputted to the sub scanning line driving circuit 7. Consequently, at an abnormal time, the sub scanning line driving circuit 7 is used without using the main scanning line driving circuit 6. Subsequently, an output from the main scanning line driving circuit 6 is brought into a high-impedance state, and thereby the signal is not outputted from the main scanning line driving circuit 6, and the signal is outputted from the sub scanning line driving circuit 7. Specifically, a VBB of an L-level signal (OFF potential) is inputted to a VSW terminal, a CLK1 terminal, and a CLK2 terminal of the V scanner block 17 of the main scanning line driving circuit 6. On the other hand, an H-level VDD potential is inputted to a VSW terminal of the V scanner block 17 of the sub scanning line driving circuit 7, a CLK1 signal of a clock signal is inputted to a CLK1 terminal, and a CLK2 signal of an inversion signal of the CLK1 signal is inputted to a CLK2 terminal. Accordingly, an output from the OUT terminal of the main scanning line driving circuit 6 is controlled to be brought into the high-impedance state. Consequently, the signal is controlled to be prevented from being outputted from the OUT terminal of the main scanning line driving circuit 6. On the other hand, an H-level VDD potential is inputted to a VSW terminal of the V scanner block 17 of the sub scanning line driving circuit 7, the CLK1 signal of the clock signal is inputted to the CLK1 terminal, and the CLK2 signal of the inversion signal of the CLK1 signal is inputted to the CLK2 terminal, and thereby a signal for driving the thin film transistor 11 of the display unit 4 is outputted from the OUT terminal of the sub scanning line driving circuit 7 to the gate line 9. Subsequently, step S4 starts.

Next, in step S4, a signal is outputted from the V scanner block 17 of the final line (N-th line) of the sub scanning line driving circuit 7 to the scanning line driving circuit control unit 16, and whether the outputted signal is normal is determined. Subsequently, the scanning line driving circuit control unit 16 determines whether the outputted signal is outside a range of approximately between −10V to +15V. Subsequently, when the outputted signal is determined to be outside the range of approximately between −10V and +15V, whether the outputted signal is normal is determined, and a control operation of step S4 is repeatedly performed. Further, in step S4, when the outputted signal is determined to be within the range of approximately between −10V to +15V, the outputted signal is determined to be abnormal, and step S5 starts. Subsequently, both the main scanning line driving circuit 6 and the sub scanning line driving circuit 7 are determined to be abnormal, the liquid crystal display device 100 is determined to be a defective product. Subsequently, the control operation is completed.

Hereinafter, detailed operations of the above described main scanning line driving circuit 6 and sub scanning line driving circuit 7 will be described with reference to FIGS. 4 to 6.

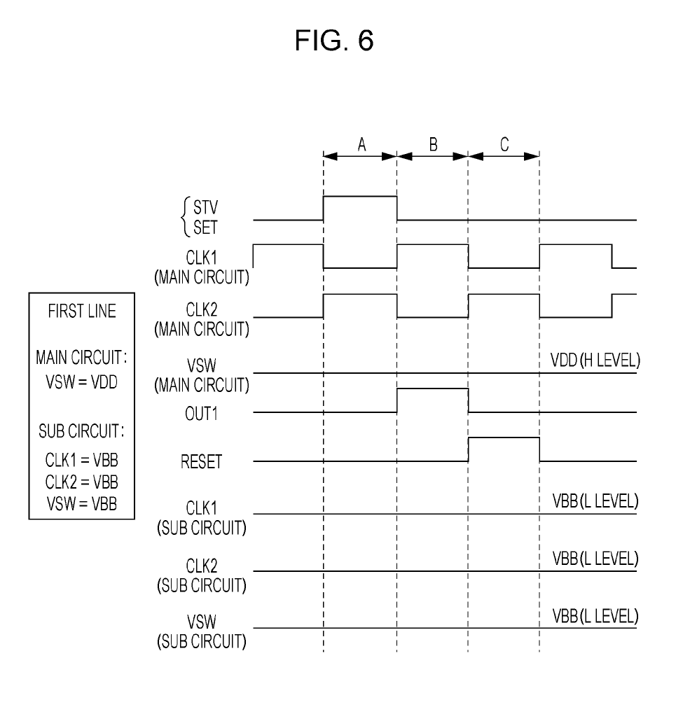

First, normally, a signal for outputting the signal driving the thin film transistor 11 installed in the pixel 3 of the display unit 4 is inputted to the main scanning line driving circuit 6, like in step S1 of the control operation of the above described scanning line driving circuit control unit 16. Specifically, in the V scanner block 17 of the first line of the main scanning line driving circuit 6 illustrated in FIG. 4, an H-level STV signal is inputted to the transistor Tr8 at a time A illustrated in FIG. 6, and thereby the transistor Tr8 is brought into an on state. Due to this, since an L-level VBB potential is inputted to a gate electrode (G) of the transistor Tr5 and a gate electrode (G) of the transistor Tr6, the transistor Tr5 and the transistor Tr6 is brought into an off state.

At the same time, an H-level SET signal is inputted to a gate electrode (G) of the transistor Tr1, and thereby the transistor Tr1 is brought into an on state. Due to this, an H-level VSW (VDD potential) is inputted to a gate electrode (G) of the transistor Tr3 and a gate electrode (G) of the transistor Tr7 through a node N1, and thereby the transistor Tr3 and the transistor Tr7 are brought into an on state. Subsequently, an L-level CLK1 signal is outputted from an OUT terminal to the gate line 9 through the transistor Tr3. Further, one electrode of the capacitor C1 is brought into an H-level and starts a charging operation.

In addition, at a time A illustrated in FIG. 6, an H-level CLK2 signal is inputted to a gate electrode (G) of the transistor Tr4, and thereby the transistor Tr4 is brought into an on state. Due to this, an L-level VBB potential is outputted from an OUT terminal to the gate line 9 through the transistor Tr4. Further, an L-level RESET signal is inputted to a gate electrode (G) of the transistor Tr2, and the transistor Tr2 is in an off state.

Next, in the V scanner block 17 of the first line of the main scanning line driving circuit 6, an L-level STV signal is inputted to the transistor Tr8 at a time B illustrated in FIG. 6, as illustrated in FIG. 4, and thereby the transistor Tr8 is brought into an off state. At the same time, an L-level SET signal is inputted to a gate electrode (G) of the transistor Tr1, and thereby the transistor Tr1 is brought into an off state. Further, in the transistor Tr3, a signal stored by the capacitor C1 charged at the time A is inputted to a gate electrode (G) of the transistor Tr3 and a gate electrode (G) of the transistor Tr7, and thereby the transistor Tr3 and the transistor Tr7 are maintained to be in the on state. In this instance, an L-level VBB potential is inputted to a gate electrode (G) of the transistor Tr5 and a gate electrode (G) of the transistor Tr6, and thereby the transistor Tr5 and the transistor Tr6 are brought into the off state. Subsequently, an H-level CLK1 signal is outputted from an OUT terminal to the gate line 9 through the transistor Tr3. Due to this, the outputted signal drives the thin film transistor 11 installed in the pixel 3 of the display unit 4. Further, the outputted signal is inputted to an SET terminal of the V scanner block 17 of the next stage. Further, a signal outputted from the V scanner block 17 connected to the gate line 9 of the final line (N-th line) is inputted to the scanning line driving circuit control unit 16.

In addition, since an L-level CLK2 signal is inputted to a gate electrode (G) of the transistor Tr4, the transistor Tr4 is brought into an off state. Further, an H-level VSW (VDD potential) is inputted to a source electrode (S) of the transistor Tr1 being in the off state. Further, an L-level RESET signal is inputted to a gate electrode (G) of the transistor Tr2, and the transistor Tr2 is in the off state.

Next, in the V scanner block 17 of the first line of the main scanning line driving circuit 6, an L-level STV signal is inputted to the transistor Tr8 at a time C illustrated in FIG. 6, as illustrated in FIG. 4, and thereby the transistor Tr8 is brought into the off state. At the same time, an L-level SET signal is inputted to a gate electrode (G) of the transistor Tr1, and thereby the transistor Tr1 is brought into the off state. Further, an L-level CLK1 signal is inputted to a source electrode (S) of the transistor Tr3. Further, an H-level CLK2 signal is inputted to a gate electrode (G) of the transistor Tr4, and thereby the transistor Tr4 is brought into the on state. Subsequently, the L-level VBB potential is outputted from the OUT terminal to the gate line 9 via the transistor Tr4.

In addition, the H-level VSW (VDD potential) is inputted to the source electrode (S) of the transistor Tr1 being in the off state. Further, the H-level RESET signal outputted from the V scanner block 17 of the second line (next stage) is inputted to the gate electrode (G) of the transistor Tr2, and thereby the transistor Tr2 is brought into the on state. Subsequently, the L-level VBB potential is inputted to the source electrode (S) of the transistor Tr5, the gate electrode (G) of the transistor Tr7, and the gate electrode (G) of the transistor Tr3 through the transistor Tr2. Due to this, the transistor Tr3 and the transistor Tr7 are brought into the off state. Further, scanning operations after the second line are the same as those of the described first line.

In addition, normally, a signal for bringing an output into a high-impedance state is inputted to the sub scanning line driving circuit 7, like in step S1 of the described control operation. Specifically, in the V scanner block 17 of the first line of the sub scanning line driving circuit 7 illustrated in FIG. 4, the H-level STV signal is inputted to the transistor Tr8 at the time A illustrated in FIG. 6, and thereby the transistor Tr8 is brought into the on state. Due to this, since the L-level VBB potential is inputted to the gate electrode (G) of the transistor Tr5 and the gate electrode (G) of the transistor Tr6 through the transistor Tr8, the transistor Tr5 and the transistor Tr6 are brought into the off state. At the same time, since the H-level SET signal is inputted to the gate electrode (G) of the transistor Tr1, the transistor Tr1 is brought into the on state. Due to this, since the L-level VSW (VDD potential) is inputted to the gate electrode (G) of the transistor Tr3 and the gate electrode (G) of the transistor Tr7 through the transistor Tr1 and the node N1, the transistor Tr3 and the transistor Tr7 are brought into the off state.

In addition, the L-level CLK1 signal (VBB potential) is inputted to the source electrode (S) of the transistor Tr3 being in the off state. Further, the L-level CLK2 signal (VBB potential) is inputted to the gate electrode (G) of the transistor Tr4, and thereby the transistor Tr4 is brought into the off state. As described above, the transistor Tr3, the transistor Tr4, and the transistor Tr6 are brought into the off state, and thereby a signal outputted to the gate line 9 from an OUT terminal connected to a drain electrode (D) of the transistor Tr3, a drain electrode (D) of the transistor Tr4, and a drain electrode (D) of the transistor Tr6 is brought into a high-impedance state (floating). Due to this, the sub scanning line driving circuit 7 is brought into a state where a signal is not outputted from the OUT terminal. Further, the L-level RESET signal is inputted to the gate electrode (G) of the transistor Tr2, and thereby the transistor Tr2 is brought into the off state.

Next, at the times B and C illustrated in FIG. 6, in the V scanner block 17 connected to the gate line 9 of the first line of the sub scanning line driving circuit 7, the L-level STV signal is inputted to the transistor Tr8, and thereby the transistor Tr8 is brought into the off state as illustrated in FIG. 4. Further, operations of other sub scanning line driving circuits 7 at the times B and C are the same as those of the sub scanning line driving circuit 7 at the time A. Further, operations after the second line of the V scanner block 17 are the same as those of the first line of the V scanner block 17.

Next, normally, whether a signal outputted from the V scanner block 17 connected to the gate line 9 of the final line (N-th line) among the main scanning line driving circuit 6 is normal or not is determined by the scanning line driving circuit control unit 16, like in step S2 of the above described control operation. Subsequently, when the outputted signal is determined to be not normal (abnormal), the signal inputted to the main scanning line driving circuit 6 is controlled to be switched to/from the signal inputted to the sub scanning line driving circuit 7, like in step S3 of the above described control operation. Specifically, after the switching (abnormally), the L-level CLK1 signal (VBB potential), the L-level CLK2 signal (VBB potential), and the L-level VSW (VBB potential) are inputted to the main scanning line driving circuit 6, the pulse-shaped CLK1 signal (clock signal), and the CLK2 signal (clock signal) of the inversion signal of the CLK1 signal and the H-level VSW (VDD signal) are inputted to the sub scanning line driving circuit 7.

Subsequently, abnormally, in the main scanning line driving circuit 6 illustrated in FIG. 4, an output of the OUT terminal of the V scanner block 17 is brought into the high-impedance state, and thereby a signal is not outputted to the gate line 9. Further, in the sub scanning line driving circuit 7, a signal is outputted from the OUT terminal of the V scanner block 17 to the gate line 9, and the thin film transistor 11 installed in the pixel 3 of the display unit 4 is driven. Further, the signal outputted to the gate line 9 connected to the final line (N-th line) of the sub scanning line driving circuit 7 is outputted to the scanning line driving circuit control unit 16, and whether the outputted signal is normal or not is determined, like in step S4 of the above described control operation. Subsequently, when the outputted signal is determined to be abnormal, both the main scanning line driving circuit 6 and the sub scanning line driving circuit 7 are determined to be defective, like in step S5 of the above described control operation, and thereby the liquid crystal display device 100 is determined to be defective.

In this embodiment, normally, the scanning line driving circuit control unit 16 is controlled so that the main scanning line driving circuit 6 outputs the signal driving the thin film transistor 11, and brings the output of the sub scanning line driving circuit 7 into the high-impedance state. Accordingly, when the signal is outputted from the main scanning line driving circuit 6, the signal is not outputted from the sub scanning line driving circuit 7, so that an increase in the power consumption can be suppressed, unlike a case where the signal is simultaneously outputted from both the main scanning line driving circuit 6 and the sub scanning line driving circuit 7. In addition, the scanning line driving circuit control unit 16 controls an output of either the main scanning line driving circuit 6 or the sub scanning line driving circuit 7 which is not used, to be brought into the high-impedance state, and thereby a signal is not outputted from either the main scanning line driving circuit 6 or the sub scanning line driving circuit 7 which is not used. Due to this, for example, a switching unit is installed between either the main scanning line driving circuit 6 or the sub scanning line driving circuit 7 which is not used and each gate line 9, and thereby a circuit configuration can be simplified, unlike the case where the signal, from either the main scanning line driving circuit 6 or the sub scanning line driving circuit 7 which is not used, is not outputted.

In addition, in this embodiment, as described above, when an output signal from the main scanning line driving circuit 6 is abnormal, the scanning line driving circuit control unit 16 controls the output of the main scanning line driving circuit 6 to be brought into the high-impedance state, and the sub scanning line driving circuit 7 performs a switching control so that the signal driving the thin film transistor 11 is outputted. Due to this, when the main scanning line driving circuit 6 is not normally driven (abnormally driven), the liquid crystal display device 100 is treated as a defective product, and the sub scanning line driving circuit 7 which is normally driven can be used instead of the main scanning line driving circuit 6 which is abnormally driven, and thereby it is possible to treat the liquid crystal display device 100 as the non-defective product. Further, when the life of the main scanning line driving circuit 6 has expired due to its deterioration, the main scanning line driving circuit 6 is switched to the sub scanning line driving circuit 7, and thereby a signal driving the thin film transistor 11 is outputted from the sub scanning line driving circuit 7. Accordingly, the life of the liquid crystal display device 100 can be doubled.

In addition, in this embodiment, as described above, when the output signal from the main scanning line driving circuit 6 is abnormal, the scanning line driving circuit control unit 16 switches between the signal inputted to the main scanning line driving circuit 6 and the signal inputted to the sub scanning line driving circuit 7, and thereby a switching control is performed so that the sub scanning line driving circuit 7 is used without using the main scanning line driving circuit 6. Due to this, the sub scanning line driving circuit 7 which is normally driven can be used instead of the main scanning line driving circuit 6 which is abnormally driven, and thereby the signal driving the thin film transistor 11 can be outputted from the sub scanning line driving circuit 7 which is normally driven.

In addition, in this embodiment, as described above, the scanning line driving circuit control unit 16 controls either the main scanning line driving circuit 6 or the sub scanning line driving circuit 7 which is not used so as to be prevented from being driven by fixing, to be in an OFF potential (L-level), the scanning line enable signal (VSW signal) as well as a clock signal (CLK1 signal and CLK2 signal) inputted to either the main scanning line driving circuit 6 or the sub scanning line driving circuit 7 which is not used, and thereby an output of either the main scanning line driving circuit 6 or the sub scanning line driving circuit 7 which is not used is controlled so as to be brought into the high-impedance state. Due to this, by only switching the scanning line enable signal (VSW signal) as well as the clock signal (CLK1 signal and CLK2 signal) into the OFF potential (L-level), the signal from either the main scanning line driving circuit 6 or the sub scanning line driving circuit 7 which is not used is readily prevented from being outputted. In particular, by only using a predetermined signal without adding an additional circuit, it is possible to be brought into the high-impedance state.

In addition, according to the embodiment, as described above, when a magnitude of a signal outputted from the V scanner block 17 of the final line of either the main scanning line driving circuit 6 or the sub scanning line driving circuit 7 which is used is within a range of between −10V to +15V, the scanning line driving circuit control unit 16 determines it as being not normal, and thereby it is possible to determine whether either the main scanning line driving circuit 6 or the sub scanning line driving circuit 7 which is used is normally driven by the magnitude of the outputted signal.

### (Application)

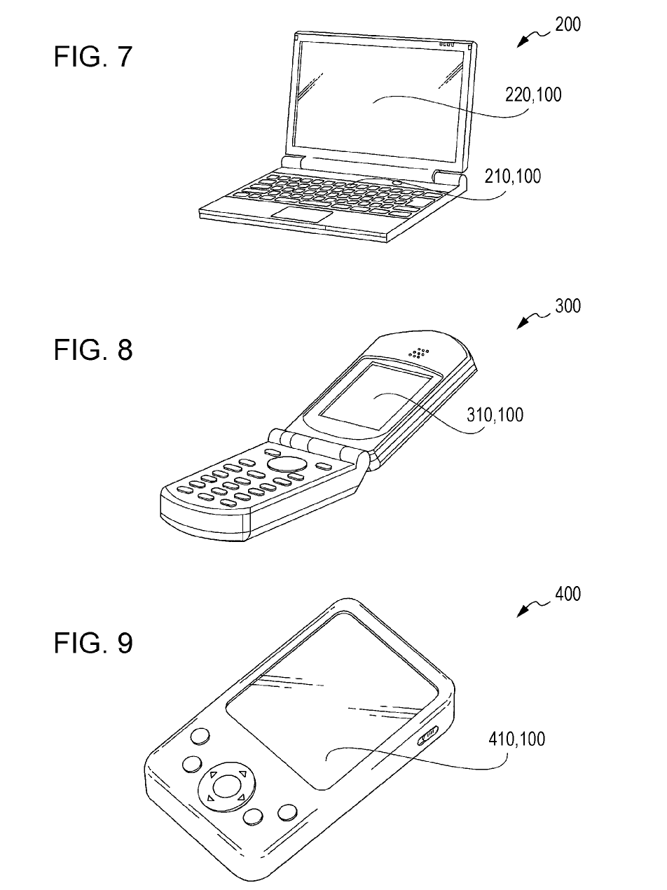

FIGS. 7 to 9 are diagrams used for describing a first example to a third example of an electronic apparatus using the above described liquid crystal display device 100 according to an embodiment. The electronic apparatus using the liquid crystal display device 100 according to an embodiment will be described in detail with reference to FIGS. 7 to 9.

As illustrated in FIGS. 7 to 9, the liquid crystal display device 100 according to an embodiment can be used in a Personal Computer 200 (PC) as the first example, a mobile phone 300 as the second example, a Personal Digital Assistant (PDA) 400 as the third example, and the like.

As for the PC 200 of the first example of FIG. 7, the liquid crystal display device 100 according to an embodiment may be used in an input unit 210 such as a keyboard, a display screen 220, and the like. As for the mobile phone 300 of the second example of FIG. 8, the liquid crystal display device 100 according to an embodiment may be used in a display screen 310. As for the PDA 400 of the third example of FIG. 9, the liquid crystal display device 100 according to an embodiment may be used in a display screen 410.

Further, the embodiments of the present application are merely examples, and are not limited. The scope of the application is indicated by the scope of the claims, not by descriptions of embodiments described above, and all changes within the scope and having the equivalent meaning to the appended claims are included.

For example, in the above embodiments, the liquid crystal display device is used as an example of the display device of the application; however, the application is not limited thereto. For example, as the display device of the present application, an organic EL device and the like other than the liquid crystal display device may be used.

In addition, in the above embodiments, the main scanning line driving circuit is applied to the first scanning line driving circuit of the application, and the sub scanning line driving circuit is applied to the second scanning line driving circuit; however, the application is not limited thereto. For example, the sub scanning line driving circuit may be applied to the first scanning line driving circuit of the application, and the main scanning line driving circuit may be applied to the second scanning line driving circuit.

In addition, in the above embodiments, so that the output of the sub scanning line driving circuit is brought into the high-impedance state, a configuration of the sub scanning line driving circuit using the transistor and the capacitor is illustrated; however, the application is not limited thereto. For example, the output of the sub scanning line driving circuit may be brought into the high-impedance state using an element and the like other than a transistor and a capacitor.

In addition, in the above embodiments, as an example in which the output of the sub scanning line driving circuit of the application is brought into the high-impedance state, the VSW signal, the CLK1 signal, and the CLK2 signal, which are inputted to each of the V scanner block of the main scanning line driving circuit and the V scanner block of the sub scanning line driving circuit, are differentiated; however, the application is not limited thereto. For example, signals other than the VSW signal, the CLK1 signal, and the CLK2 signal may be differentiated, so that the output of the sub scanning line driving circuit may be brought into the high-impedance state.

In addition, in the above embodiments, as an example in which whether the signal outputted from the V scanner block is normal or not is determined, whether the output signal is within the range of between −10V to +15V is determined; however, the application is not limited thereto. For example, the signal outputted from the V scanner block may be outside the range between −10V to +15V.

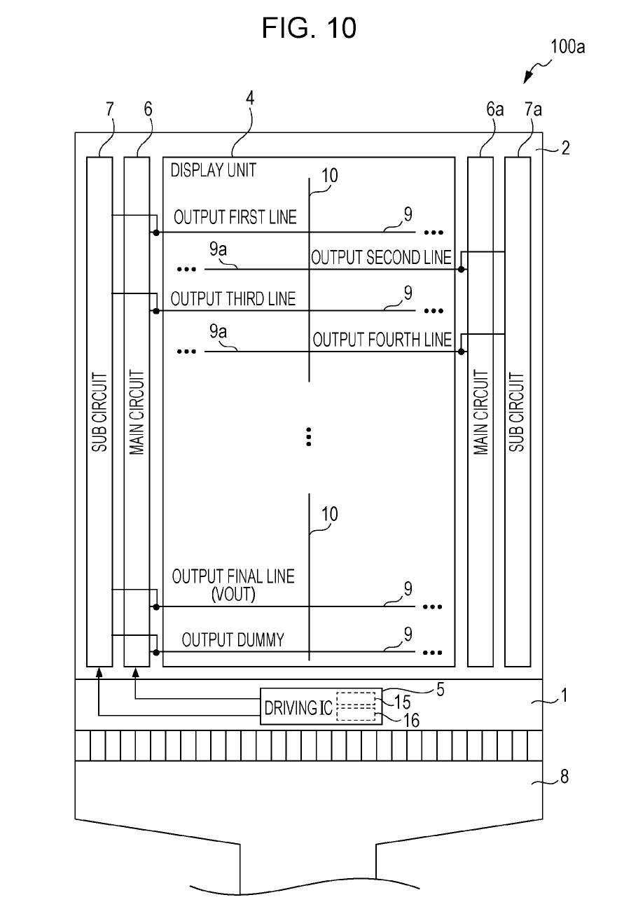

In addition, in the above embodiments, the main scanning line driving circuit and the sub scanning line driving circuit are arranged one by one; however, the present application is not limited thereto. For example, like a liquid crystal display device 100a of a modified example illustrated in FIG. 10, a main scanning line driving circuit 6a and a sub scanning line driving circuit 7a may be arranged in addition to the main scanning line driving circuit 6 and the sub scanning line driving circuit 7. In this case, the gate line 9 of odd numbered lines (the first line, the third line, . . . ) is connected to the main scanning line driving circuit 6 and the sub scanning line driving circuit 7, and the gate line 9a of even numbered lines (the second line, the fourth line, . . . ) is connected to the main scanning line driving circuit 6a and the sub scanning line driving circuit 7a.

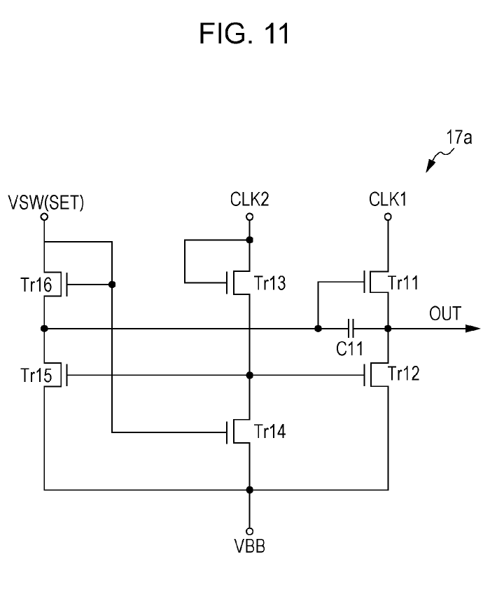

In addition, in the above embodiments, the V scanner block 17 is configured of eight transistors and two capacitors; however, the application is not limited thereto. For example, like a V scanner block 17a of a modified example illustrated in FIG. 11, the V scanner block 17a may be configured of six transistors (transistors Tr11, Tr12, Tr13, Tr14, Tr15, and Tr16) and a single capacitor (C11). For example, in the scanning line driving circuit being used, when the H-level clock signal is inputted to a CLK1 terminal of the V scanner block 17a, the L-level clock signal is inputted to a CLK2 terminal, the H-level clock signal is inputted to a VSW terminal (SET terminal), and the L-level VBB potential is inputted to a VBB terminal, the signal driving the thin film transistor installed in the pixel of the display unit is outputted from the OUT terminal. Further, in the scanning line driving circuit not being used, the L-level OFF potential is inputted to the CLK1 terminal, the CLK2 terminal, the VSW terminal (SET terminal), and the VBB terminal of the V scanner block 17a. In this case, since the transistor Tr16 is brought into the off state, the signal is not inputted to the gate electrode of the transistor Tr11. Accordingly, the signal outputted from the transistor Tr11 to the OUT terminal may be brought into the high-impedance state. Further, since the transistor Tr13 is brought into the off state, the signal is not inputted to the gate electrode of the transistor Tr12. Accordingly, the signal outputted from the transistor Tr12 to the OUT terminal may be brought into the high-impedance state.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A display device, comprising:
a switching element that is formed for each pixel;
a gate line that is connected to the switching element;
a first scanning line driving circuit and a second scanning line driving circuit that are connected to the gate line; and
a control unit that normally controls the first scanning line driving circuit to output a signal driving the switching element, and controls an output of the second scanning line driving circuit to be brought into a high-impedance state.

2. The display device according to claim 1,
wherein when an output signal from the first scanning line driving circuit is abnormal, the control unit controls an output of the first scanning line driving circuit to be brought into the high-impedance state, and the second scanning line driving circuit performs a switching control so that the signal driving the switching element is outputted.

3. The display device according to claim 2,
wherein a signal for outputting the signal driving the switching element is inputted to the first scanning line driving circuit,
a signal for bringing an output into the high-impedance state is inputted to the second scanning line driving circuit, and
when the output signal from the first scanning line driving circuit is abnormal, the control unit performs a switching control of using the second scanning line driving circuit without using the first scanning line driving circuit by switching the signal inputted to the first scanning line driving circuit and the signal inputted to the second scanning line driving circuit to each other.

4. The display device according to claim 3,
wherein the control unit controls the first scanning line driving circuit to be prevented from being driven by fixing at least a clock signal, among the signals inputted to the first scanning line driving circuit, to be in an OFF potential, so that the output of the first scanning line driving circuit is brought into the high-impedance state.

5. The display device according to claim 4,
wherein the control unit controls the first scanning line driving circuit to be prevented from being driven by fixing not only the clock signal but also a scanning line enable signal, among the signals inputted to the first scanning line driving circuit, to be in the OFF potential, so that the output of the first scanning line driving circuit is brought into the high-impedance state.

6. The display device according to of claim 3,
wherein each of the first scanning line driving circuit and the second scanning line driving circuit include a transistor connected to the gate line through which a signal is outputted, and
the control unit controls the transistor connected to the gate line to be brought into an off state by fixing a signal, inputted to a gate electrode of the transistor of the first scanning line driving circuit, to be in the OFF potential, so that the output of the first scanning line driving circuit is brought into the high-impedance state.

7. The display device according to claim 1,
wherein the control unit determines whether the output signal from any one of the first scanning line driving circuit and the second scanning line driving circuit is abnormal.

8. An electronic apparatus including the display device according to claim 1.
